(19) United States
(12) Patent Application Publication
(10) Pub. No.: US 2002/0179741 A1
(43) Pub. Date: Dec. 5, 2002

(54) Gardening pistol nozzle structure having transparent handle and nozzle

(75) Inventor: Chin-Yuan Chen, Chang-Hua Hsien (TW)

Correspondence Address: John S. Egbert, Harrison & Egbert, 1018 Preston St. # 100, Houston, TX, 77002, US

(73) Assignee: Shin Tai Spurt Water of the Garden Tools Co., Ltd.

(21) Appl. No.: 09/870,553

(22) Filed: Jun. 1, 2001

(51) Int. Cl. B05B 9/01

(52) U.S. Cl. 239/526

(57) ABSTRACT

A gardening pistol nozzle comprises a handle and a nozzle, which are either transparent or translucent. The handle and the nozzle have one color or multiple colors. The handle and the nozzle may be different in color. The nozzle is provided with an emitting cap of a disk-shaped or conical construction.

### BACKGROUND OF THE INVENTION

1. Field of the Invention

The present invention relates generally to a gardening implement, and more particularly to a pistol nozzle having a transparent handle and a transparent nozzle.

2. Description of Related Art

There are a variety of conventional pistol nozzles available in the market place today. These conventional pistol nozzles are monotonous in design in that they all look alike, thereby resulting in lack of uniqueness and competitiveness of the conventional pistol nozzles.

### BRIEF SUMMARY OF THE INVENTION

The primary objective of the present invention is to provide a gardening pistol nozzle with an enhanced esthetic effect to promote the marketability of the gardening pistol nozzle.

In keeping with the principle of the present invention, the foregoing objective of the present invention is attained by a gardening pistol nozzle comprising a handle, a barrel, a nozzle, and a control lever. The handle and the nozzle are either transparent or translucent, so as to make the flow of water visible.

The objective, feature, and function of the present invention will be more readily understood upon a thoughtful deliberation of the following detailed description of the present invention with reference to the accompanying drawings.

### BRIEF DESCIPTION OF THE SEVERAL VIEWS OF THE DRAWINGS

FIG. 1 shows a side schematic view of a first preferred embodiment of the present invention.

FIG. 2 shows a side schematic view of a second preferred embodiment of the present invention.

FIG. 3 shows a side schematic view of the present invention at work.

### DETAILED DESCRIPTION OF THE INVENTION

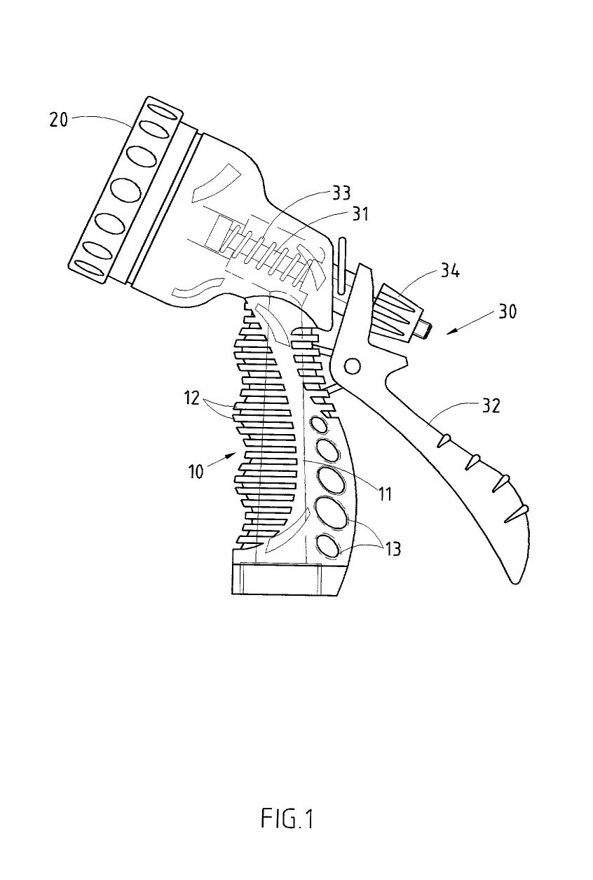

As shown in FIGS. 1-3, a gardening pistol nozzle embodied in the present invention is formed of a handle 10, a nozzle 20, a water control member 30, and a control lever 32.

The handle 10 is made of a transparent or translucent material and is provided in the interior with a water duct 11 which is visible. The nozzle 20 is made of a transparent or translucent material and is provided with a water control member 30 which is formed of a water stopping rod 31, a control lever 32 pivoted at one end with the water stopping rod 31, and a recovery spring 33 fitted over the water stopping rod 31 for providing the water stopping rod 31 with a recovery force. The water stopping rod 31 is provided at an outer end with a position confining nut 34 fastened therewith.

As shown in FIG. 1, the nozzle cap is of a disk-shaped construction.

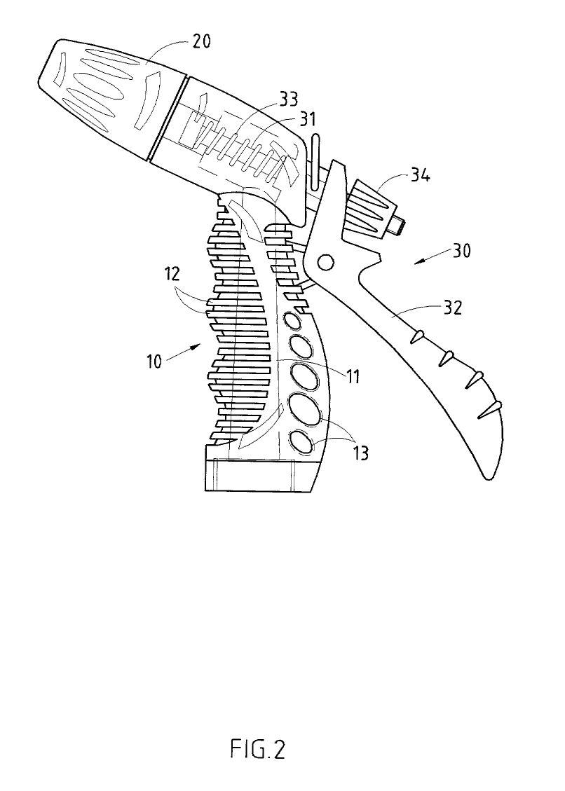

As shown in FIG. 2, the nozzle cap is of a conic construction.

The handle 10 is provided on the outer surface with a plurality of elastic pieces 12 and knobs 13. The elastic pieces 12 are intended to soothe the hand holding the handle 10. The knobs 13 have a skidproof effect.

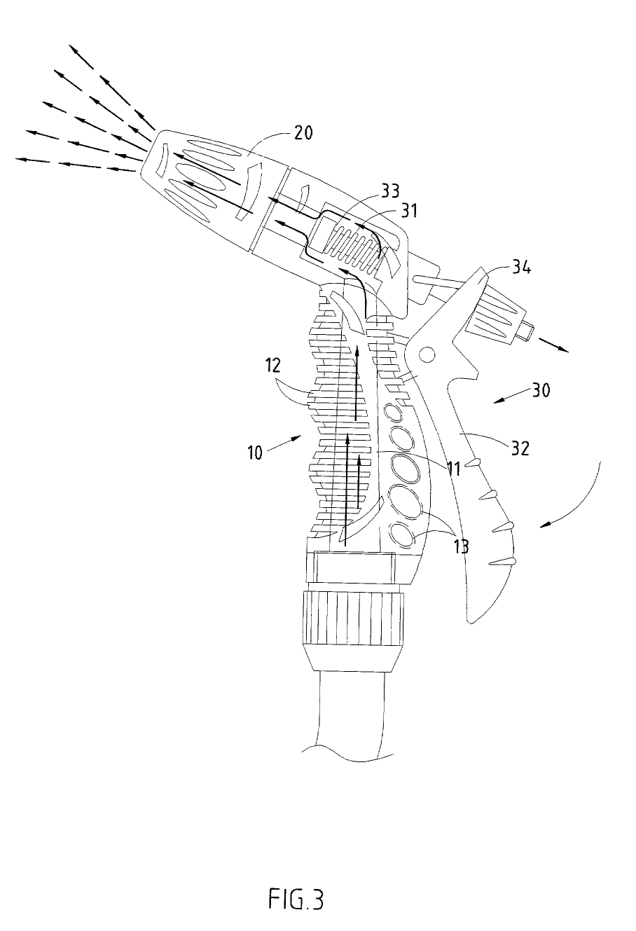

In light of the handle 10 and the nozzle 20 being transparent or translucent, the state of flow of water in the handle 10 and the nozzle 20 is visible. The operational actions of the water stopping rod 31 and the recovery spring 33 are also visible, as illustrated in FIG. 3.

The versatility of the gardening pistol nozzle of the present invention serves to enhance the marketability of the gardening pistol nozzle of the present invention.

The present invention described above is to be regarded in all respects as being merely illustrative and not restrictive. Accordingly, the present invention may be embodied in other specific forms without deviating from the spirit thereof. For example, the handle 10 and the nozzle 20 of the gardening pistol nozzle of the present invention may be different in color. In addition, the handle 10 or the nozzle 20 may have one color or multiple colors. The present invention is therefore to be limited only by the scopes of the following appended claims.

I claim:

1. A gardening pistol nozzle comprising a handle, and a nozzle connected with the handle and provided with a control lever pivoted thereto; wherein said handle and said nozzle are made of a transparent or translucent material.

2. The gardening pistol nozzle as defined in claim 1, wherein said handle and said nozzle are different in color.

3. The gardening pistol nozzle as defined in claim 1, wherein said handle or said nozzle has one color.

4. The gardening pistol nozzle as defined in claim 1, wherein said handle or said nozzle has multiple colors.

5. The gardening pistol nozzle as defined in claim 1, wherein said nozzle has a cap of a disk-shaped construction.

6. The gardening pistol nozzle as defined in claim 1, wherein said nozzle has a cap of a conic construction.

7. The gardening pistol nozzle as defined in claim 1, wherein said handle is provided on an outer surface with a plurality of skin-soothing elastic pieces and skidproof knobs.
